(19) United States
(12) Patent Application Publication
(10) Pub. No.: US 2007/0147660 A1
(43) Pub. Date: Jun. 28, 2007

(54) Image processing system for motor vehicles

(75) Inventors: Emrullah Durucan, Munchen (DE); Uwe Franke, Uhingen (DE); Axel Gern, Leutenbach (DE); Stefan Hahn, Ulm (DE); Carsten Knoeppel, Stuttgart (DE); Michael Smuda Von Trzebiatowski, Albstadt-Tailfingen (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Daimier Chrysler AG, Stuttgart (DE)

(21) Appl. No.: 10/546,509

(22) PCT Filed: Feb. 20, 2004
(86) PCT No.: PCT/EP04/01715

§ 371 Date: Jun. 19, 2006

(30) Foreign Application Priority Data
Feb. 22, 2003 (DE) 103-07-607.

(51) Int. Cl. G06K 9/00; G01C 22/00

(52) U.S. Cl. 382/104; 701/28

(57) ABSTRACT

An image processing system for a motor vehicle, includes a camera system, an image processing module having a data interface for receiving image data produced by the camera system, a memory unit for storing an image processing program, an image processor unit for processing the image data, a display unit for displaying the processed image data, and a miniature computer. At least one of the image processor unit and the display unit are disposed in the miniature computer.

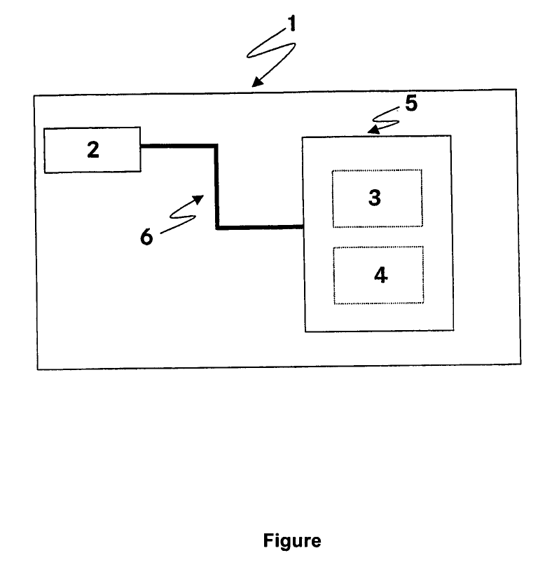

The present invention is directed to an image processing system for motor vehicles according to the features set forth in the definition of the species in claim 1.

To an increasing degree, modern motor vehicles come equipped with driver assistance and safety systems. Image-processing systems in particular, which process camera image data taken from the surrounding field or the interior of a motor vehicle, are gaining in importance, the processed image data being made available in their entirety or in segments to the vehicle driver or to internal vehicle systems. When image processing is used in the motor vehicle, however, it must satisfy a broad array of requirements.

The German patent application DE 198 52 631 A1 describes a system for recognizing road signs which provides for those image components in the image data recorded by a camera system in which a road sign is imaged to be identified by the image processing unit. Following the identification process, the image processing unit extracts these image regions and presents them to the vehicle driver via a display unit for final evaluation.

The German patent application DE 199 26 559 A1 discusses a complex image processing method in which the image data of a multi-camera system are evaluated and displayed. In this connection, by fusing the image data of the surrounding area immediately ahead of a vehicle that are captured from different directions of view, distance-resolved image data material is generated. On the basis of these data, the image processing unit estimates the distances to objects and determines their relative velocities.

The German patent application DE 101 24 005 A1 describes an image processing system which is adapted to the processing of the image data received by a camera that is sensitive in the infrared wavelength range. In this case, the image processing system identifies different regions in the image data by using classification algorithms and, depending on the class they belong to, superimposes on these regions, textures that are familiar to an individual observer.

A device for determining data indicative of the course of a lane is described by the German patent DE 197 49 086 C1. The device includes a lane detection sensor system composed, in particular, of an image recording and image processing system, as well as an object-position and vehicle ego-motion sensor system. In this case, the measured data recorded by the sensor system are fed to an estimator which contains a dynamic vehicle motion model, in order to determine the course of the lane and/or the position and orientation of detected objects relative to the lane.

These image processing systems, which are presented exemplarily and are known from the related art, are implemented by using vehicle-specific control unit approaches. In this context, with respect to their electromechanical properties, particularly their temperature resistance and temperature stability, the control units are to be engineered to withstand greatly fluctuating and sometimes extreme operating conditions that prevail in the motor vehicle; thus, temperatures often rise to very high levels inside a vehicle in the summer, especially under conditions of exposure to strong sunlight. In addition, the individual system components of the control units must meet stringent service life requirements, especially in view of the typically very long running life of a motor vehicle. Due to the aforementioned factors, in particular, camera-based driver assistance and safety systems entail relatively high development and production costs.

The object of the present invention is, therefore, to devise an image processing system for motor vehicles which will entail comparatively low development and production costs, in a way that will not significantly limit functionality or reliability. Correspondingly, it is intended to provide a driver assistance system and a vehicle having an image processing system that is likewise inexpensive and reliable.

This objective is achieved by a device having the features set forth in claims 1, 11 and 12. Advantageous embodiments and refinements of the present invention are described in the dependent claims.

In accordance with the present invention, an image processing system for motor vehicles is provided, which includes a camera system, an image processing module having a data interface for receiving image data produced by the camera system, as well as a memory unit for storing an image processing program and a processor unit for processing the image data. In addition, the image processing system has a display unit for displaying the processed image data. Along the lines of the present invention, the image processing system has a miniature computer, in particular a palmtop, personal digital assistant (PDA) or a cell phone, whose processor module and/or whose display are used as an image processing module and/or as a display unit. The present invention provides an image processing system for motor vehicles which places modest demands on the electro-mechanical properties and the service life of the system components. In addition, a vehicle is provided by the present invention which includes a plurality of image processing systems according to the present invention. By using a plurality of image processing systems of this type, it is possible to detect a multiplicity of different surrounding field areas or even the complete 360° surrounding field area around the vehicle, in a cost-effective manner. In addition, it is also possible to combine surrounding field information from at least two different image processing systems and/or camera systems, in order to generate depth information therefrom. A plurality of image processing systems may also be used in order to offer different types of information to a plurality of passengers. Along the lines of the present invention, the image processing system is used in a vehicle as part of a driver assistance system. Driver assistance systems of this kind may be so-called ACC systems or proximity warning systems, for example, an obstacle detection being carried out for purposes of collision avoidance. Driver assistance systems, whose purpose is to recognize road signs, are also known. The image processing system according to the present invention is preferably used in connection with so-called lane keeping systems. A lane keeping assistance system of this kind warns the driver, for example, when the vehicle leaves its lane (lane departure warning) or controls the vehicle semi-automatically or fully automatically (lane keeping) in a way that keeps it moving within the lane. In this connection, by using the image processing system, it is possible for the lane course to be detected and the vehicle position relative to the lane to be evaluated very precisely, while entailing little outlay for hardware.

In accordance with one advantageous embodiment of the present invention, a mounting bracket for accommodating the miniature computer is located in the passenger compartment of the motor vehicle. In this context, the mounting bracket is designed and positioned in a way that facilitates placement of the miniature computer in the same, in particular at a location that is visible to at least one of the passengers. In this context, a mechanical connection is provided between the miniature computer and the mounting bracket, preferably through the use of a clamping or plug-in mechanism. However, any other means known to one skilled in the art in the area of audio and video equipment, communications electronics or vehicle technology are conceivable which are suited for attaching an electronic device, in particular a miniature computer, using a mounting bracket, in a vehicle. In this case, a preferred mounting location that is visible to at least one of the passengers is, for example, in the area of the vehicle cockpit, on the instrument panel. This makes it possible for the driver to retrieve information directly from the miniature computer display, without having to avert his/her eyes for too long from the road. For example, on the miniature computer display, information may be presented to the driver regarding the route up ahead, for example the course of the lane, the distance to detected objects, the traffic situation, or other vehicle surrounding-field information.

One embodiment of the present invention also advantageously provides that a mounting bracket for accommodating the miniature computer situated in the passenger compartment of the motor vehicle be designed and positioned in a way that facilitates placement of the miniature computer in the same, at a location that is not visible to any of the passengers. In this context, one especially preferred location is, in particular, between the windshield and the rearview mirror of the motor vehicle. The miniature computer may be attached, together with the mounting bracket, to the back side of the rearview mirror, for example, it being optionally possible for the housing of the rearview mirror to be designed to itself form the mounting bracket for accommodating the miniature computer. Another preferred location is, for example, above the instrument panel, the miniature computer then resting flat on the instrument panel or being at least partially recessed in the instrument panel in a cutout or recess. In the case that the camera system is directly mechanically connected to the miniature computer or is integrated in the same, the mounting bracket and the miniature computer situated in the same are preferably oriented in such a way that at least a portion of the vehicle's surrounding field, for example the route up ahead, is captured by the camera system.

Since a mounting bracket for accommodating the miniature computer is located in the passenger compartment of the motor vehicle and is designed and positioned in a way that, in particular, enables the miniature computer to be releasably secured in the same, it is advantageously possible to take along the miniature computer as a mobile companion device, when leaving the vehicle. A releasable mounting arrangement enables, above all, used or older vehicles to be simply retrofitted with the image processing system according to the present invention or expanded to include supplementary miniature computers. However, since it is already possible to obtain miniature computers and, in particular, cell phones very inexpensively, miniature computers of this kind may also be permanently installed in a vehicle. In this context, the miniature computer may also be placed at least partially behind a mechanical cover in the passenger compartment.

In accordance with another advantageous embodiment of the present invention, the mounting bracket for accommodating the miniature computer or the cell phone includes optical and/or mechanical elements which make the camera system adaptable with respect to its shooting direction. As a result, the shooting direction is able to be adapted very effectively to the particular assistance function. For example, surrounding field information of a specific area may be deflected in a deliberate, controlled manner by optical lenses, mirrors and/or mechanical swing/tilting devices situated on the mounting bracket, toward the optical system of the camera system. It is also advantageously possible in this manner to install the miniature computer at a location that is protected by a cover from environmental conditions and/or mechanical influences. If, in this case, the camera system is directly mechanically connected to the miniature computer, then this cover merely requires a small cutout for the optical system of the camera system.

In connection with the image processing system according to the present invention, it is advantageously possible to select the shooting direction of the camera system in a way that enables the vehicle's surrounding field and/or the passenger compartment to be recorded. For example, the image processing system may be used in addition to the previously mentioned assistance functions or exclusively for observing vehicle occupants. Vehicle occupants are observed, for example, by detecting the driver's line of sight, by determining the head position in connection with the triggering of safety systems, or by detecting drowsiness when drowsy-driving warning systems are used. Generally, the shooting direction may be selected manually by an occupant or automatically, for example as a function of the driving direction.

In an especially preferred manner, in connection with the image processing system according to the present invention, a miniature computer is used which has its own integrated camera system, whose generated image data are processed by the image processing system. In this context, cell phones and personal digital assistants (PDAs) are particularly suited for use in motor vehicles. Devices of this kind have integrated camera modules, whose optical and electronic properties, such as resolution and luminosity control, are already of a quality that suffices for image-assisted assistance functions in motor vehicles.

In this connection, the surrounding field information captured and/or evaluated by the image processing system may be displayed directly on the display of the miniature computer and/or possibly acoustically reproduced by a speaker integrated in the miniature computer. It is also optionally or additionally possible to transmit the acquired information to other internal vehicle systems, for example to an already present multifunctional display or to the motor vehicle's audio system. It is also possible, however, to transmit information from internal vehicle systems to the image processing system according to the present invention and for the image processing system to utilize this information. The transmission may be carried out in this case both via a dedicated circuit, as well as via wireless transmission, using Bluetooth technology, for example. In the case of a wireless transmission, it is advantageous that, at most, one wiring interconnection is needed for the electric power supply. It is also possible, however, for the miniature computer to be operated autonomously. In addition, it is also possible for information to be exchanged with external vehicle systems via a wireless transmission.

Other features and advantages of the present invention are derived from the following description of a preferred exemplary embodiment, reference being made to the FIGURE. In this context, the FIGURE illustrates the novel image processing system for motor vehicles. The image processing system includes a camera system (2), an image processing module (3) for processing the image data supplied by the camera system, as well as a display unit (4) for displaying the processed image data. In this connection, the image processing module is composed of a data interface for receiving image data produced by the camera system, a memory unit for storing an image processing program, and a processor unit for processing the image data. Along the lines of the present invention, the image processing module and the display unit are situated in a miniature computer (5), in particular a palmtop or personal digital assistant (PDA), or in a cell phone. The miniature computer is designed to be able to be detachably secured in the passenger compartment of the motor vehicle, at a location that is visible to at least one of the passengers.

By integrating image processing module (3) in passenger compartment (1), it is ensured that it is not exposed to any great temperature fluctuations or extreme temperatures, as are frequently encountered when integrating such units in a conventional manner in a control unit in the engine compartment. This is because passenger compartment (1) of motor vehicles is typically cooled during vehicle operation by air-conditioning or by a controlled ventilation to room temperature or at least to outside-air temperature. In particular, by using a miniature computer (5) for the function of an internal-vehicle image processing module and display unit, it is additionally ensured that it does not remain in a parked vehicle, but rather is taken along by the driver or by another vehicle occupant, due to its additional functionalities. Thus, typically, image processing module (3) does not remain in a motor vehicle parked in the blazing sun.

In this manner, by installing image processing module (3) as part of a miniature computer (5) in passenger compartment (1) of the motor vehicle along the lines of the present invention, the demands placed on the electromechanical properties are reduced. It follows self-evidently that, by installing miniature computer (5) in the passenger compartment of the motor vehicle, one substantially reduces the outlay entailed in protecting the image processing module from the ingress of moisture and condensation moisture.

Due to the fact that image processing module (3) and display (4) of the image processing device are advantageously constituted of the processor module and the display of a miniature computer (5), in particular those of a palmtop, personal digital assistant (PDA) or cell phone, the demands placed on the longevity of the system may also be substantially lessened. While it is necessary to ensure the functional duration of conventional systems, in particular due to their high costs and the considerable outlay required for an eventual replacement, if possible, for the entire running life of a motor vehicle (about 12 years), it is now common for owners of miniature computers to replace them within a period of time (two to three years) that is relatively short compared to the running life of a motor vehicle. Enabling such an exchange or replacement not only substantially reduces the demands placed on the longevity of an image processing system, but, at the same time, continuously enhances the performance of the image processing system, since a considerable improvement in processor performance is noted in each new generation of miniature computers. By replacing the miniature computer with a modern model variant, the user of the image processing system is able, at the same time, to adapt his/her display device to an up-to-date standard. In this context, modern miniature computers have operating systems which enable the devices to be upgraded, without having to adapt the software in the process.

From the research and development of image processing systems for motor vehicles it is, in fact, already known to use flexibly configurable computer systems having dedicated displays for processing and displaying of image signals. However, these are complex, flexibly configurable development systems, whose computer systems are often located in the trunk of the vehicle, and which are operated via commercial PC keyboards. For the most part, customary LCD PC displays, which are fixed to the instrument panel, are used to visually present the image data. In cases where the development of the image processing software is already in an advanced stage and, thus, no longer requires all too much processor power, it is, in fact, known to implement it on laptops located in the passenger compartment. However, due to the weight of the computers, mechanical problems arise with respect to vibration-free support requirements. For this reason, one often reverts to temporarily securing the laptop to the front passenger seat or to holding it in one's lap or hands during vehicle operation. As pointed out here, all of these arrangements known from the research and development sector constitute interim solutions which are not suited for production vehicles and are also not at all intended for such uses. It has been shown that the approaches normally taken by experts in the field, following a successful phase of testing the image processing algorithms, ultimately result in these algorithms always being used in connection with a special control unit hardware. Transferring the image processing algorithms to a control unit is not only self-evident to one of average skill in the art, due to the approaches normally taken in this field of activity, but it is also readily apparent, based on his/her knowledge of the unwieldiness of the development systems and of the small amount of available installation space already claimed by a broad array of interest groups.

Departing from the usual image processing system, in the case of the novel image processing system according to the present invention, besides requisite display (4), image processing module (3) also still remains in passenger compartment (1). However, in contrast to the known research and development systems, the components, reduced to a scope that is absolutely necessary, are compactly integrated in one single housing, a miniature computer (5). Due to its low weight, miniature computer (5) is, for the most part, adequately supported in a secure and safe manner by a mechanically simple mounting bracket.

The present invention eliminates the need existing in known methods heretofore, for permanently reserving a place for integrating a fixedly installed display in the area of the instrument panel, since the display is part of miniature computer (5), whose mounting bracket may be mounted at any desired, visible location. It is even conceivable that it be left up to the user of the image processing system to decide the location where to place miniature computer (5) in passenger compartment (1). It is equally possible to provide a plurality of optional mounting brackets, so that, depending on the particular application, the miniature computer may be positioned at different locations. Such applications include, for example, displaying traffic signs to the driver or displaying images of the surroundings to occupants seated on the back seats of the vehicle. It is not only conceivable in a particularly effective manner for a plurality of mounting brackets to be installed in the vehicle in a distributed fashion, but also for a plurality of miniature computers having integrated image processing modules to be used in parallel for a broad array of applications. This merely requires that each of image processing modules (3) be in contact with the camera system or with one of a plurality of camera systems via a communications link (6).

In addition, by integrating image processing module (3) in the vehicle in a detachable manner, the advantage is derived that one and the same module may be used in a plurality of vehicles. Thus, a driver is able to purchase one single image processing module and use it in a plurality of vehicles by carrying along the miniature computer that has been appropriately configured. Thus, the need is also eliminated, for example, for car rental companies to equip each of the vehicles of their fleet with a special image processing system. Should an unanticipated need arise for more systems than currently available, additional units may then be quickly acquired and made available, since a complicated and expensive control unit installation is no longer necessary.

By using a conventional miniature computer (5), which is also becoming increasingly popular among vehicle owners, the processor power and quality of the display are continuously enhanced for the service life of the image processing system. From an economic standpoint, in particular, the present invention makes it easily possible for a broad palette of systems having different performance levels to be offered, in that the software optimized for the particular image processing task is offered on a broad array of miniature computers. It may suffice for some tasks to use a monochrome display unit or, on the other hand, systems having, in fact, limited functionality, but offered inexpensively on miniature computers of the latest generation of devices.

Usage of the image processing system is able to be improved very beneficially by providing the miniature computer with a data interface via which image processing programs are able to be read into its memory unit. This enables new and improved algorithms for processing and displaying images to be installed on the system in a simple manner. Thus, not only by continuously replacing the system hardware (miniature computers), but also by adapting the system software on a regular basis, is one able to effectively adapt the system to advancing development and increasing demands.

Image processing algorithms, which differ greatly with respect to the intended application and development state, may be offered in a very effective manner to users of the image processing system. This opens up additional possibilities for the manufacturer of the image processing system to add value. It becomes possible for such a manufacturer to market the image processing algorithms within the framework of a software product on a broad array of storage media. It is also conceivable to use the Internet as a distribution channel, for example, and to offer the software products as free or fee-based downloads on the web site of the manufacturer of the image processing system or of the vehicle manufacturer whose vehicles are configured for accommodating such a system. Thus, the user of the novel image processing system may optimally adapt it to his/her requirements by acquiring and using these special computer program products.

When permitted by the memory of the miniature computer, it is conceivable to install algorithms for a broad array of image processing processes, in parallel. These include, for example, algorithms for evaluating image data of an infrared system, image data of a multi-camera system, or special algorithms used for pedestrian detection in city centers. Generally, the processor power will not suffice for executing all of these complex tasks in parallel. For that reason, in particular, the miniature computer should be effectively provided with input means which enable processing algorithms or display modes to be selected which are best suited for the particular circumstances. These could best be implemented by a menu navigation using the standard keyboard of the miniature computer.

The camera module assigned to the image processing module and display unit located in the miniature computer may be permanently integrated in the vehicle and be connected thereto via an interface located in the mounting bracket of the miniature computer. In this connection, it is conceivable to design the camera module to be detachable from the cabling between the camera module and miniature computer, so that, if the need arises, the camera module may be replaced and thus adapted to technical advancements. In such a case, a motor vehicle may be assembled in a standard production with a cabling system onto which a suitable camera may mounted, if the need arises, for example, if optional equipment including an image processing system is desired. On the other hand, in this way, the vehicle user is also provided with the opportunity of using his/her own, already available camera as a camera system for the image processing system. A mounting bracket in the motor vehicle that is preferably universally adaptable to a broad array of popular camera modules is particularly suited for this purpose. It is equally conceivable, however, that, apart from a mounting fixture for the miniature computer and, if indicated, a universal mounting fixture for the camera module, no further preassembly of the motor vehicle be needed. For the most part, image recording systems composed of miniature computers and camera modules, along with a corresponding communications circuit (for example connector line), are already commercially available. Such complete systems could be easily placed in mounting brackets located in the vehicle. At this point, by replacing the software typically installed on such miniature computers and purely suited for recording images, with complex image processing software, then, in contrast to the originally intended application of pure image recording (photography) or image transmission (videotelephony), an image processing system is created that has flexible uses in the motor vehicle.

The functionality of the novel image processing system may also be enhanced, in particular, by providing the miniature computer with an interface via which data may be transferred to and from internal vehicle systems. Such internal vehicle systems are, in particular, driver assistance systems, which are able to act in a controlling manner on the vehicle dynamics in dangerous situations (for example: braking or avoidance action when obstacles are present or warning of the driver).

1-12. (canceled)

13. An image processing system for a motor vehicle, comprising:
a camera system configured to produce image data;
an image processing module having a data interface for receiving the image data produced by the camera system, a memory unit for storing an image processing program;
an image processor unit for processing the image data into processed image data;
a display unit for displaying the processed image data; and
a miniature computer, wherein at least one of the image processor unit and the display unit are disposed in the miniature computer.

14. The image processing system for motor vehicles, wherein the miniature computer includes at least one of a palmtop, a personal digital assistant, and a cell phone.

15. An image processing system for motor vehicles as recited in claim 13, further comprising a mounting bracket for accommodating the miniature computer disposed at a location in passenger compartment of the motor vehicle.

16. The image processing system as recited in claim 15, wherein the location is readily visible to at least one passenger of the motor vehicle.

17. The image processing system as recited in claim 15, wherein the location is not readily visible to any of the passengers.

18. The image processing system as recited in claim 17, wherein the location is disposed between a windshield and a rearview mirror of the motor vehicle.

19. The image processing system as recited in claim 15, wherein the mounting bracket is configured to releasably secure the miniature computer.

20. The image processing system as recited in claim 15, wherein the mounting bracket including at least one of an optical and a mechanical element configured to adapt the camera system with respect to a shooting direction o the camera system.

21. The image processing system as recited in claim 13, the camera system is operable in a shooting direction, the shooting direction being selectable to record at least one of a surrounding field and a passenger compartment of the vehicle.

22. The image processing system as recited in claim 13, wherein the miniature computer has an integrated camera system and the image processing system processing a generated image of the integrated camera system.

23. The image processing system as recited in claim 13, wherein the miniature computer has an additional data interface through which data may be transferred to or from an internal vehicle system.

24. The image processing system as recited in claim 13, wherein the miniature computer has an additional data interface through which image processing programs may be read into the memory unit.

25. The image processing system as recited in claim 13, wherein the miniature computer has input device capable of influencing the image processor unit.

26. A vehicle comprising a plurality of image processing systems as recited in claim 13.

27. A vehicle driver assistance system for supporting a driver of the vehicle and warning the driver in the event of imminent danger, wherein the vehicle driver assistance system includes an image processing system as recited in claim 13.
